(19) United States
(12) Patent Application Publication
(10) Pub. No.: US 2021/0396834 A1
(43) Pub. Date: Dec. 23, 2021

(54) APPARATUS FOR DIRECTION FINDING IN BLUETOOTH COMMUNICATION SYSTEM AND METHOD THEREOF

(71) Applicant: ABOV Semiconductor co., Ltd., Cheongju-si (KR)

(72) Inventor: Ki Tae MOON, Seoul (KR)

(73) Assignee: ABOV Semiconductor co., Ltd., Cheongju-si (KR)

(21) Appl. No.: 17/353,726

(22) Filed: Jun. 21, 2021

(30) Foreign Application Priority Data
Jun. 22, 2020 (KR) 10-2020-0075703

(51) Int. Cl. G01S 3/48; G01S 3/04

(52) U.S. Cl. CPC G01S 3/48; G01S 3/043

(57) ABSTRACT

A device and method for direction finding in a Bluetooth communication system is proposed. The device for direction finding in the Bluetooth communication system includes: an antenna array including a plurality of antennas, the antenna array including a first antenna and a second antenna which are installed along a first direction and a third antenna and a forth antenna which are installed along a second direction perpendicular to the first direction; a receiver electrically connected to the plurality of antennas and configured to transmit or receive a signal through the antenna array; and a controller electrically connected to the receiver and configured to perform controlling of the receiver and processing of the received signal.

### CROSS REFERENCE TO RELATED APPLICATION

The present application claims priority to Korean Patent Application No. 10-2020-0075703, filed Jun. 22, 2020, the entire contents of which is incorporated herein for all purposes by this reference.

### BACKGROUND OF THE INVENTION

### Field of the Invention

The present invention relates to a device and method for direction finding in a Bluetooth communication system and, more particularly, to a device and method for direction finding, wherein a direction in which a signal is received is detected by way of arranging antennas and utilizing a phase difference for each antenna in an electronic device using Bluetooth communication.

### Description of the Related Art

As a standard for short-range wireless communication between electronic devices, a Bluetooth communication system (or Bluetooth Low Energy, BLE) is widely used. Bluetooth communication provides resources for wireless communication in a relatively short distance between electronic devices by using a frequency band of 2.4 to 2.485 GHz.

Meanwhile, a function for direction finding is added in the Bluetooth 5.1 standard. The direction finding in Bluetooth may be realized by a method of estimating an angle of arrival by using two or more antennas to calculate a phase difference of signals between the antennas according to a reception angle of the signals.

Typically, an angle of arrival (AoA) method is used in direction finding in Bluetooth, wherein two or more antennas are installed in a receiver, and a phase difference of signals between the antennas is calculated. When it is inevitably difficult to install two or more antennas in the receiver, an angle of departure (AoD) method may be used, wherein two or more antennas are installed in a transmitter to calculate a phase difference of signals between the antennas.

### SUMMARY OF THE INVENTION

An exemplary embodiment of the present invention provides a method for measuring a phase difference between antennas by using a constant tone extension (CTE) signal of Bluetooth, and calculating an angle of arrival by using the measured phase difference.

In addition, the exemplary embodiment of the present invention provides a device and method for arranging antennas in a two-dimensional space for calculating an angle of arrival and an incident direction of a Bluetooth signal.

In addition, the exemplary embodiment of the present invention provides the device and method for arranging antennas in a three-dimensional space for measuring an azimuth angle and an elevation angle of a Bluetooth signal.

The problems to be solved of the present invention are not limited to those mentioned above, and other problems not mentioned will be clearly understood by those skilled in the art from the following description.

A device for direction finding in a Bluetooth communication system according to the exemplary embodiment of the present invention includes: an antenna array including a plurality of antennas, the antenna array including a first antenna and a second antenna which are installed along a first direction and a third antenna and a forth antenna which are installed along a second direction perpendicular to the first direction; a receiver electrically connected to the plurality of antennas and configured to transmit or receive a signal through the antenna array; and a controller electrically connected to the receiver and configured to perform controlling of the receiver and processing of the received signal. The receiver receives a packet signal including a constant tone extension (CTE), and the CTE includes: a first set of samples received by the first antenna during a first period; a second set of samples received by the second antenna during a second period; a third set of samples received by the third antenna during a third period; and a fourth set of samples received by the fourth antenna during a fourth period. The controller determines: a first phase value of the first set of samples; a second phase value of the second set of samples; a third phase value of the third set of samples; and a fourth phase value of the fourth set of samples, and determines an angle of arrival and an incident direction of the packet signal on the basis of a first-axis phase difference corresponding to a difference between the first phase value and the second phase value and a second-axis phase difference corresponding to a difference between the third phase value and the fourth phase value.

In the exemplary embodiment, the packet signal may include a preamble, an access address, a protocol data unit (PDU), a cyclic redundancy check (CRC), and the CTE, and the CTE is inserted after the CRC.

In the exemplary embodiment, the first phase value may be an average phase value of samples received by the first antenna during the first period, the second phase value may be an average phase value of samples received by the second antenna during the second period, the third phase value may be an average phase value of samples received by the third antenna during the third period, and the fourth phase value may be an average phase value of samples received by the fourth antenna during the fourth period.

In the exemplary embodiment, the angle of arrival of the packet signal may be determined on the basis of the first-axis phase difference, a distance between the first antenna and the second antenna, and a wavelength of the packet signal, and the incident direction of the packet signal may be determined on the basis of the first-axis phase difference and the second-axis phase difference.

Here, the distance between the first antenna and the second antenna may be less than or equal to half the wavelength of the packet signal.

In the exemplary embodiment, the antenna array may further include a fifth antenna and a sixth antenna which are installed along a third direction perpendicular to the first direction and the second direction, and the CTE may further include a fifth set of samples received by the fifth antenna during a fifth period, and a sixth set of samples received by the sixth antenna during a sixth period. The controller may determine a fifth phase value of the fifth set of samples and a sixth phase value of the sixth set of samples, determine a third-axis phase difference corresponding to a difference between the fifth phase value and the sixth phase value, and determine an azimuth angle and an elevation angle, at which the packet signal is incident, on the basis of the first-axis phase difference, the second-axis phase difference, and the third-axis phase difference.

In the exemplary embodiment, the receiver may include: an antenna switch and an antenna switching controller which are configured to select an antenna to receive a radio frequency (RF) signal from among the plurality of antennas; and a demodulator configured to demodulate the RF signal received from the selected antenna.

In addition, the controller may extract a reference sample and initial phase values of the first set of samples to sixth set of samples from the CTE through In-phase/Quadrature (I/Q) sampling, calculate a frequency offset of the packet signal by using the reference sample, determine the first phase value to the sixth phase value by performing compensation on the initial phase values by using the frequency offset, determine the first-axis phase difference, the second-axis phase difference, and the third-axis phase difference from the first to the sixth phase values, and determine the azimuth angle and the elevation angle, at which the packet signal is incident, on the basis of the first-axis phase difference, the second-axis phase difference, and the third-axis phase difference.

A method for direction finding in a Bluetooth communication system according to the exemplary embodiment of the present invention includes: receiving a packet signal including a constant tone extension (CTE) through an antenna array including a plurality of antennas, the CTE including a first set of samples received by a first antenna during a first period, a second set of samples received by a second antenna during a second period, a third set of samples received by a third antenna during a third period, and a fourth set of samples received by a fourth antenna during a fourth period; determining a first phase value of the first set of samples, a second phase value of the second set of samples, a third phase value of the third set of samples, and a fourth phase value of the fourth set of samples; and determining an angle of arrival and an incident direction of the packet signal on the basis of a first-axis phase difference corresponding to a difference between the first phase value and the second phase value and a second-axis phase difference corresponding to a difference between the third phase value and the fourth phase value.

In the exemplary embodiment, the packet signal may include a preamble, an access address, a protocol data unit (PDU), a cyclic redundancy check (CRC), and the CTE, and the CTE may be inserted after the CRC.

In the exemplary embodiment, the first phase value may be an average phase value of samples received by the first antenna during the first period, the second phase value may be an average phase value of samples received by the second antenna during the second period, the third phase value may be an average phase value of samples received by the third antenna during the third period, and the fourth phase value may be an average phase value of samples received by the fourth antenna during the fourth period.

In the exemplary embodiment, the angle of arrival of the packet signal may be determined on the basis of the first-axis phase difference, the distance between the first antenna and the second antenna, and a wavelength of the packet signal, and the incident direction of the packet signal may be determined on the basis of the first-axis phase difference and the second-axis phase difference.

In the exemplary embodiment, the distance between the first antenna and the second antenna may be less than or equal to half the wavelength of the packet signal.

In the exemplary embodiment, the antenna array may further include: a fifth antenna; and a sixth antenna, the fifth and sixth antennas installed along a third direction perpendicular to the first direction and the second direction, and the CTE may further include: a fifth set of samples received by the fifth antenna during a fifth period; and a sixth set of samples received by the sixth antenna during a sixth period.

In the exemplary embodiment, the method for direction finding in a Bluetooth communication system may further include: determining a fifth phase value of the fifth set of samples and a sixth phase value of the sixth set of samples, determining a third-axis phase difference corresponding to a difference between the fifth phase value and the sixth phase value, and determining an azimuth angle and an elevation angle, at which the packet signal is incident, on the basis of the first-axis phase difference, the second-axis phase difference, and the third-axis phase difference.

In the exemplary embodiment, the receiving of the packet signal may include: selecting an antenna to receive a radio frequency (RF) signal from among the plurality of antennas; and performing demodulation on the RF signal received from the selected antenna.

In the exemplary embodiment, the determining of the first phase value and the second phase value may include: extracting a reference sample and the first set of samples to sixth set of samples from the CTE through In-phase/Quadrature (I/Q) sampling; determining initial phase values of the first set of samples to sixth set of samples; calculating a frequency offset from the reference sample; and determining the first phase value to the sixth phase value by performing compensation on the initial phase values by using the frequency offset.

In addition, the determining of the angle of arrival of the packet signal may include: determining the first-axial phase difference, the second-axial phase difference, and the third-axial phase difference from the first phase value to sixth phase value; and determining the azimuth angle and the elevation angle, at which the packet signal is incident, on the basis of the first-axis phase difference, the second-axis phase difference, and the third-axis phase difference.

According to the exemplary embodiment of the present invention, effective direction finding in the Bluetooth communication system may be performed by measuring the phase difference between antennas by using the constant tone extension (CTE) signal of Bluetooth, and calculating the angle of arrival by using the measured phase difference.

In addition, according to the exemplary embodiment of the present invention, the angle of arrival and the incident direction of a Bluetooth signal may be calculated by arranging two antennas in each of two directions perpendicular to each other in the two-dimensional space.

In addition, according to the exemplary embodiment of the present invention, the azimuth angle and the elevation angle, which are perpendicular to each other, of the Bluetooth signal may be measured by arranging two antennas in each of three directions perpendicular to each other in the three-dimensional space.

Effects of the present invention are not limited to those mentioned above, and other effects not mentioned will be clearly understood by those skilled in the art from the following description.

### BRIEF DESCRIPTION OF THE DRAWINGS

FIG. 1 is a view showing a structure of a packet in a Bluetooth communication system.

FIG. 2 is a view showing an example of a CTE having a length of 40 us in a packet of Bluetooth according to an exemplary embodiment of the present invention.

FIG. 3 is a view showing a procedure for calculating an angle of arrival according to the exemplary embodiment of the present invention.

FIG. 4 is a view showing a relationship between a phase difference and an angle of arrival of a received signal for each antenna according to the exemplary embodiment of the present invention.

FIG. 5 is a view showing an example of an angle of arrival and a phase difference when two antennas are arranged in a horizontal axis direction according to the exemplary embodiment of the present invention.

FIG. 6 is a view showing an example of an angle of arrival and a phase difference when two antennas are arranged in a vertical direction according to the exemplary embodiment of the present invention.

FIG. 7 is a view showing an example in which four antennas are vertically arranged on a horizontal axis and a vertical axis according to the exemplary embodiment of the present invention.

FIG. 8 is a view showing an azimuth angle and an elevation angle in a three-dimensional space according to the exemplary embodiment of the present invention.

FIG. 9 is a view showing an example of an arrangement of antennas for calculating the azimuth angle and the elevation angle in the three-dimensional space according to the exemplary embodiment of the present invention.

FIG. 10 is a view showing an arrangement of six antennas and a structure of a receiver for calculating the azimuth angle and the elevation angle in the three-dimensional space according to the exemplary embodiment of the present invention.

FIG. 11 is a view showing an example of a device for direction finding in the Bluetooth communication system according to the exemplary embodiment of the present invention.

FIG. 12 a view showing an example of a process for direction finding in the Bluetooth communication system according to the exemplary embodiment of the present invention.

### DETAILED DESCRIPTION OF THE INVENTION

Hereinafter, exemplary embodiments of the present disclosure will be described in detail with reference to the accompanying drawings so that those skilled in the art can easily implement the present disclosure. The present disclosure is not limited to the exemplary embodiments described herein and may be embodied in many different forms.

In order to clearly describe the present disclosure, parts irrelevant to the description are omitted, and the same reference numerals designate the same or similar components throughout the specification.

In addition, in various exemplary embodiments, components having the same configuration will be described only in representative exemplary embodiments by using the same reference numerals, and in other exemplary embodiments, only configurations different from the representative exemplary embodiments will be described.

Throughout the specification, when a part is said to be “connected (or coupled)” to another part, an expression such as “connected (or coupled)” is intended to include not only “directly connected (or coupled)” but also “indirectly connected (or coupled)” having a different member interposed therebetween. In addition, when a part is said to “include” or “comprise” a certain component, it means that it may further include or comprise other components, except to exclude other components unless the context clearly indicates otherwise.

Unless otherwise defined, all terms including technical and scientific terms used herein have the same meaning as commonly understood by one of ordinary skill in the art to which the present invention belongs. It will be further understood that terms as defined in dictionaries commonly used herein should be interpreted as having a meaning that is consistent with their meaning in the context of this specification and the relevant art and will not be interpreted in an idealized or overly formal sense unless expressly so defined herein.

Hereinafter, a device and method for direction finding in a Bluetooth communication system according to an exemplary embodiment of the present invention will be described. In order to calculate a signal phase for each antenna, a constant tone extension (CTE) providing a constant periodic signal, is allowed to be added to a rear end of a conventional packet in the Bluetooth 5.1 standard. When a bit rate is 1 Mbps, a CTE signal is a 250 kHz tone signal with a period of 4 us. A constant phase value may be obtained by collecting each sample every 4 us for such a periodic signal. Therefore, a phase difference between antennas is calculated by collecting a phase sample of the CTE signal from each antenna, and an angle of arrival may be calculated by using the phase difference.

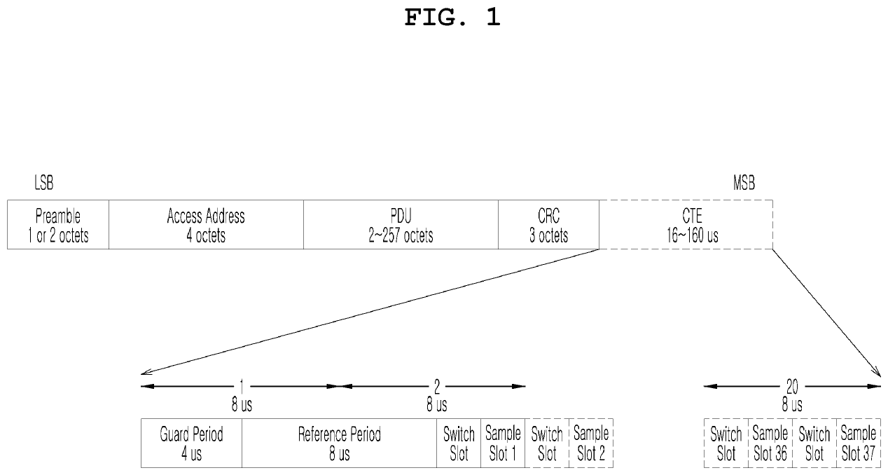

FIG. 1 is a view showing a structure of a packet in the Bluetooth communication system. Referring to FIG. 1, the packet according to Bluetooth 5.1 is composed of a preamble, an access address, a protocol data unit (PDU), a cyclic redundancy check (CRC), and a constant tone extension (CTE). The preamble includes a bitstream for bit synchronization or frame synchronization between devices, the access address includes address information for connection in a link layer, the PDU includes control data and data exchanged between the devices, and the CRC includes data for checking for data errors.

The CTE is a part newly introduced in Bluetooth 5.1 for direction finding, and may be selectively added to the rear end of the CRC in a packet. The CTE has a length of 16 to 160 us, and is composed of a guard period of 4 us, a reference period of 8 us, and a plurality of switching slots and sample slots.

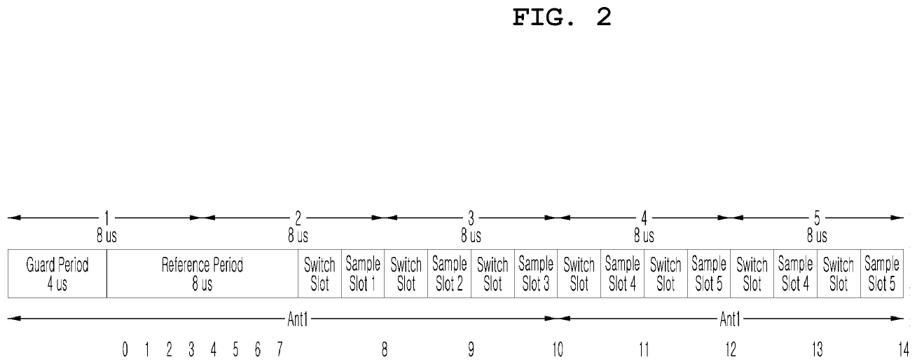

FIG. 2 is a view showing an example of a CTE having a length of us in a packet of Bluetooth according to the exemplary embodiment of the present invention. In the Bluetooth communication system, a receiver collects 8 samples in a reference period, and obtains 7 samples by collecting a sample for each sample slot. A case of antenna switching is illustrated such that first, samples 0 to 7 are reference samples, next, samples 8 to 10 are samples of a first antenna, and then, samples 11 to 14 are samples of a second antenna.

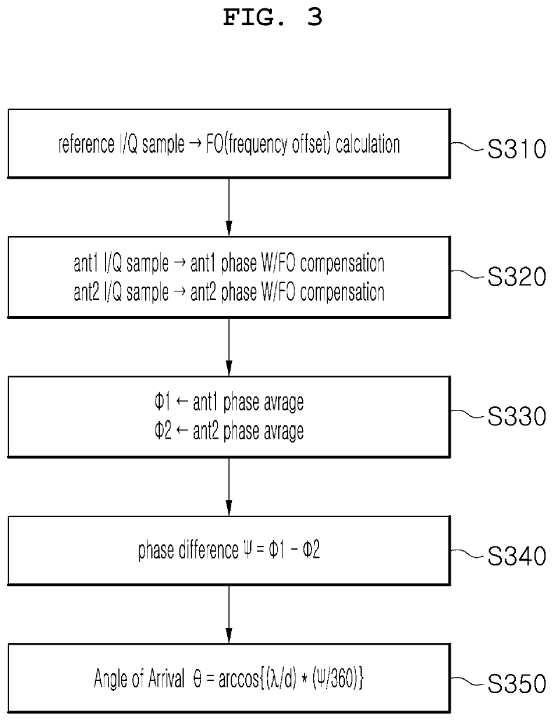

FIG. 3 is a showing a procedure for calculating an angle of arrival according to the exemplary embodiment of the present invention. Referring to FIG. 3, first, in step S310, a receiver estimates a frequency offset by using a reference sample. After that, in step S320, the receiver respectively converts the samples received for each antenna into phases, and compensates a phase value by using the frequency offset estimated in step S310. Then, in step S330, the receiver calculates a phase value (i.e., average phase value) Φ1 of the first antenna and a phase value (i.e., average phase value) Φ2 of the second antenna. Next, in step S340, the receiver calculates a phase difference between the antennas (Ψ=Φ1−Φ2). Thereafter, in step S350, the receiver calculates an angle of arrival (i.e., θ=cos⁻¹ [λ/d*Ψ/360]) by using the calculated phase difference Ψ.

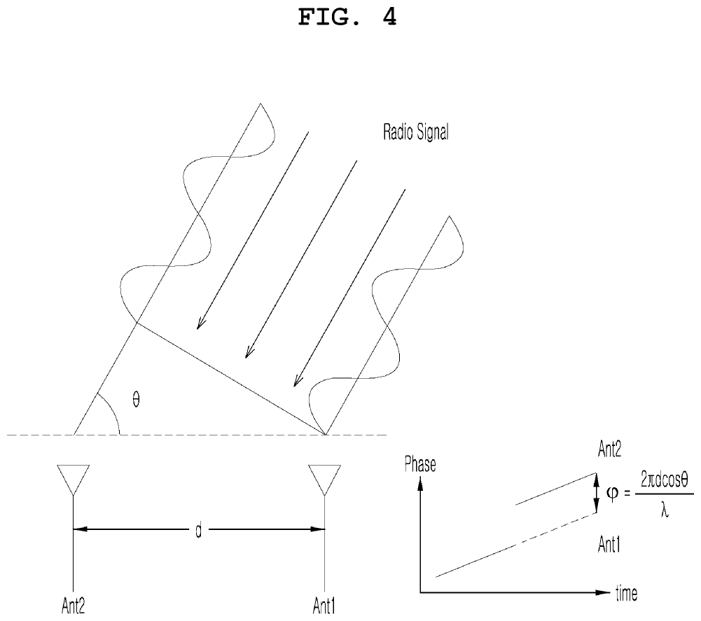

FIG. 4 is a view showing a relationship between a phase difference and an angle of arrival of a received signal for each antenna according to the exemplary embodiment of the present invention. Referring to FIG. 4, it may be seen that a path difference occurs between antennas according to the angle of arrival θ of the received signal, whereby the phase difference Ψ occurs between the antennas. The angle of arrival θ and the phase difference Ψ have a relationship of Ψ=2π(d/λ)cos(θ). In this case, considering that −1<=cos(θ)<=1, the phase difference Ψ has a range of −2π(d/λ)<=Ψ<=2π(d/λ). In order for the phase difference Ψ to be uniquely determined according to the angle of arrival θ, the phase difference Ψ should be limited to a range of −π<=Ψ<=π. Therefore, it may be seen that a relationship between a distance d between antennas and a wavelength λ of the received signal should satisfy a condition: d<=λ/2. In the present invention, a case will be described, wherein a distance (i.e., d=λ/2) between antennas is maximized in order to increase discrimination power of calculation of an angle of arrival. Hereinafter, the relationship between an angle of arrival θ and a phase difference Ψ according to an antenna arrangement will be examined, and a method of arranging antennas for calculating an azimuth angle and an elevation angle will be described.

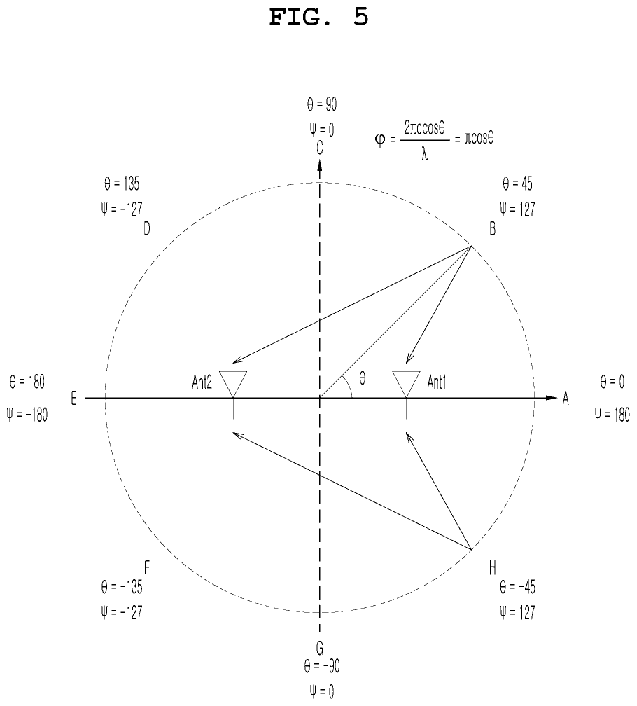

FIG. 5 shows an example of an angle of arrival and a phase difference when two antennas are arranged in a horizontal axis direction according to the exemplary embodiment of the present invention. When angles of arrival θx and phase differences Ψx at points A to H shown in FIG. 5 are summarized in a table, the results are shown in Table 1. It may be seen that when antennas are arranged in the horizontal axis (i.e., x-axis) direction, 0 degrees to 180 degrees for the angles of arrival may be distinguished on the basis of the horizontal axis. Since the phase differences are the same at points positioned symmetrical to the horizontal axis (i.e., x-axis), the entire 360-degree angle of arrival may be indistinguishable. For example, as shown in FIG. 5, point B and point H are indistinguishable because the points B and H have the same phase difference. Similarly, points C and G are indistinguishable, and points D and F are indistinguishable as well.

TABLE 1

| | A | B | C | D | E | F | G | H |
|---|---|---|---|---|---|---|---|---|
| θx | 0 | 45 | 90 | 135 | 180 | 225 | 270 | 315 |
| Ψx | 180 | 127 | 0 | −127 | −180 | −127 | 0 | 127 |

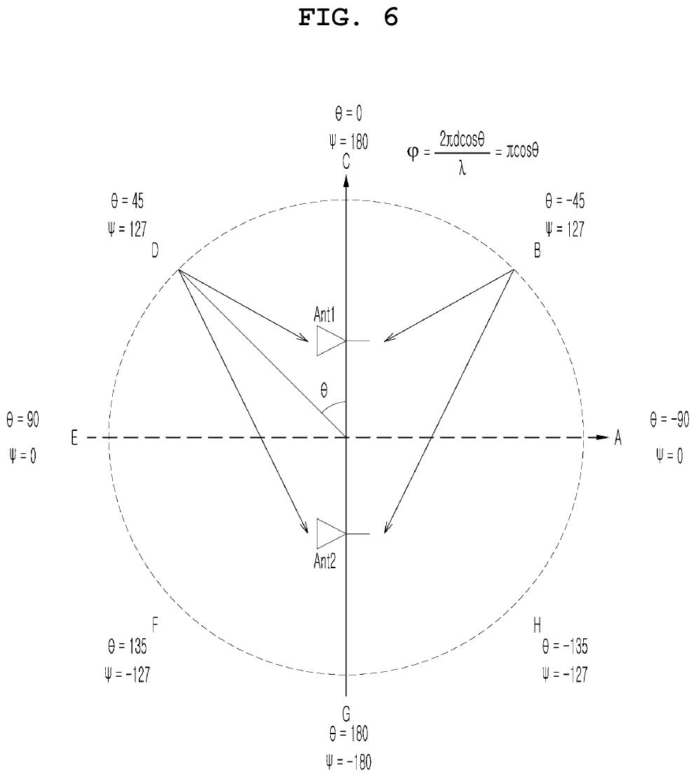

FIG. 6 is a view showing an example of an angle of arrival and a phase difference when two antennas are arranged in a vertical direction according to the exemplary embodiment of the present invention. When angles of arrival θy and phase differences Ty at points A to H shown in FIG. 6 are summarized in a table, the results are shown in Table 2. Even when antennas are arranged in the vertical axis (i.e., y-axis) direction, it may be seen that 0 degrees to 180 degrees for the angles of arrival may be distinguishable on the basis of the vertical axis. Since the phase differences are the same at points positioned symmetrical to the vertical axis (i.e., y-axis), the entire 360-degree angle of arrival may be indistinguishable.

TABLE 2

| | A | B | C | D | E | F | G | H |
|---|---|---|---|---|---|---|---|---|
| θy | 270 | 315 | 0 | 45 | 90 | 135 | 180 | 225 |
| Ψy | 0 | 127 | 180 | 127 | 0 | −127 | −180 | −127 |

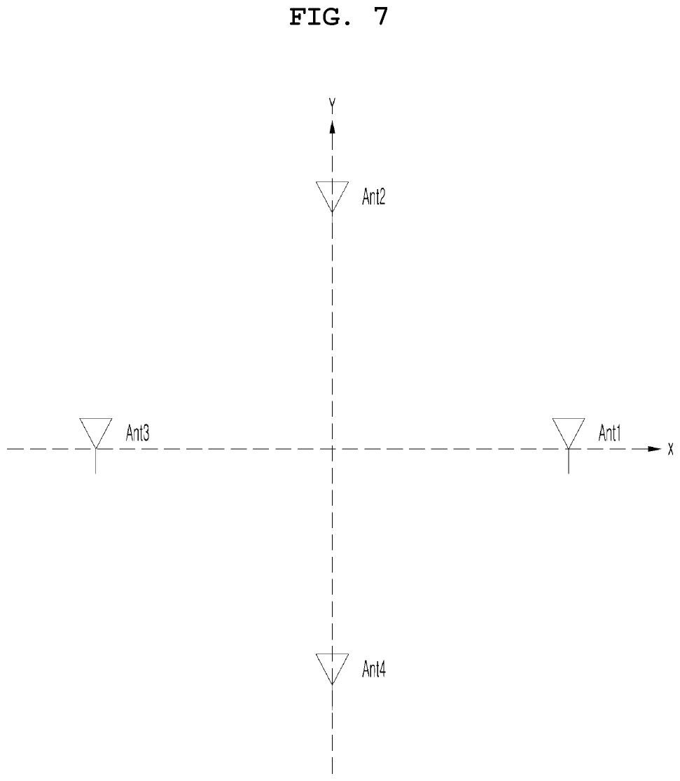

As described above, it may be seen that angles of arrival in the range of 0 degrees to 360 degrees may be indistinguishable with only two antennas. Accordingly, in order to solve this problem, a method using four antennas is presented below. FIG. 7 is a view showing an example in which four antennas are vertically arranged on the horizontal axis and the vertical axis according to the exemplary embodiment of the present invention.

When four antennas are vertically arranged on the horizontal axis and the vertical axis, the angles of arrival in all ranges of 0 degrees to 360 degrees in a two-dimensional plane may be distinguishable. As shown in Table 3 below, it may be seen that all angles of arrival from the first quadrant to the fourth quadrant may be distinguished by combining the horizontal phase difference Ψx and the vertical phase difference Ψy.

TABLE 3

| Quadrant | Ψx & Ψy |
|---|---|
| First Quadrant | 0 ≤ Ψx ≤ 180, 0 ≤ Ψy ≤ 180 |
| Second Quadrant | −180 ≤ Ψx ≤ 0, 0 ≤ Ψy ≤ 180 |
| Third Quadrant | −180 ≤ Ψx ≤ 0, −180 ≤ Ψy ≤ 0 |
| Fourth quadrant | 0 ≤ Ψx ≤ 180, −180 ≤ Ψy ≤ 0 |

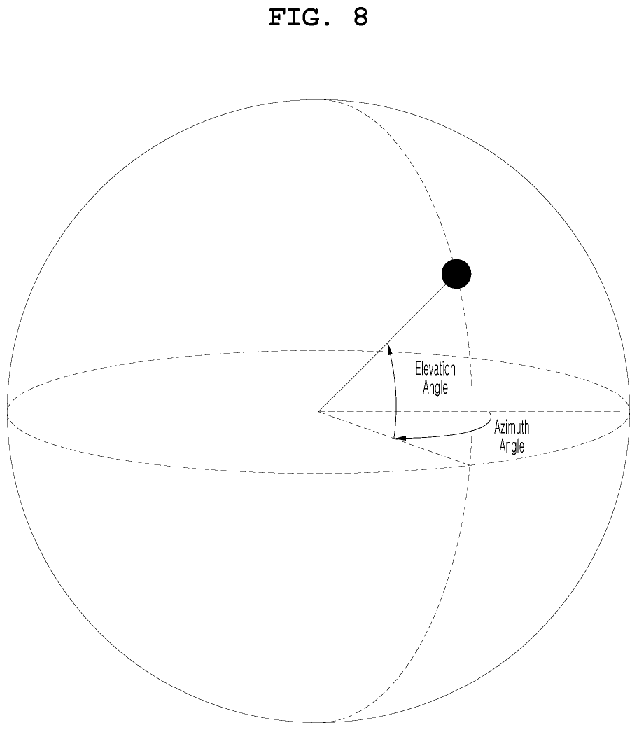

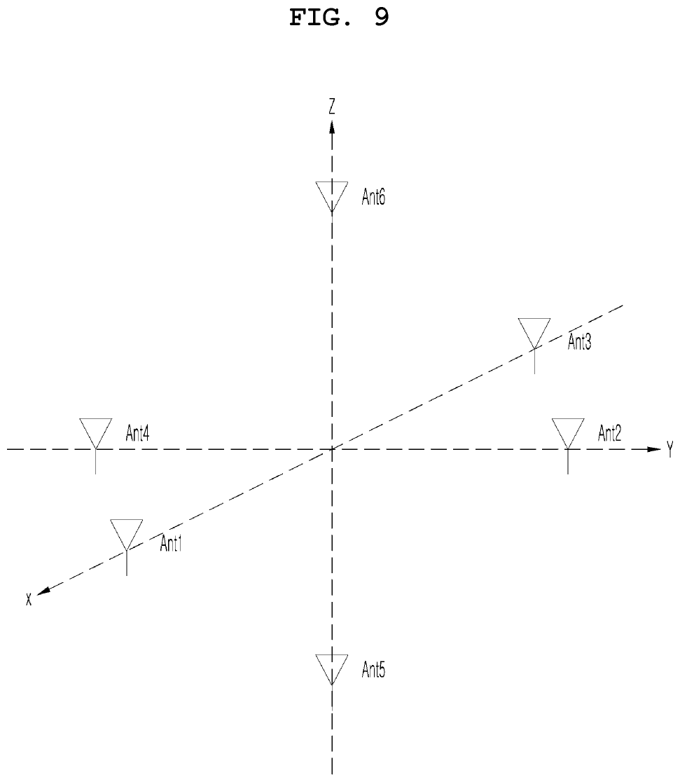

FIG. 8 is a view showing an azimuth angle and an elevation angle in a three-dimensional space according to the exemplary embodiment of the present invention. The azimuth angle and the elevation angle respectively correspond to longitude and latitude in a geographic coordinate system. In order to find a direction in the three-dimensional space, azimuth angles in the range of 0 degrees to 360 degrees and elevation angles in the range of 0 degrees to 180 degrees may be calculated. FIG. 9 is a view showing an example of an antenna arrangement for calculating the azimuth angle and the elevation angle in the three-dimensional space according to the exemplary embodiment of the present invention. In the antenna array of FIG. 6, six antennas are arranged so as to be orthogonal to the x-axis, the y-axis, and the z-axis, wherein an azimuth angle may be calculated by using four antennas on the x-axis and y-axis, and an elevation angle may be calculated by using two antennas on the z-axis. That is, the receiver may calculate the azimuth angle in the range of 0 degrees to 360 degrees by using a phase difference Ψx and a phase difference Ty, and calculate the elevation angle in the range of 0 degrees to 180 degrees by using a phase difference Ψz.

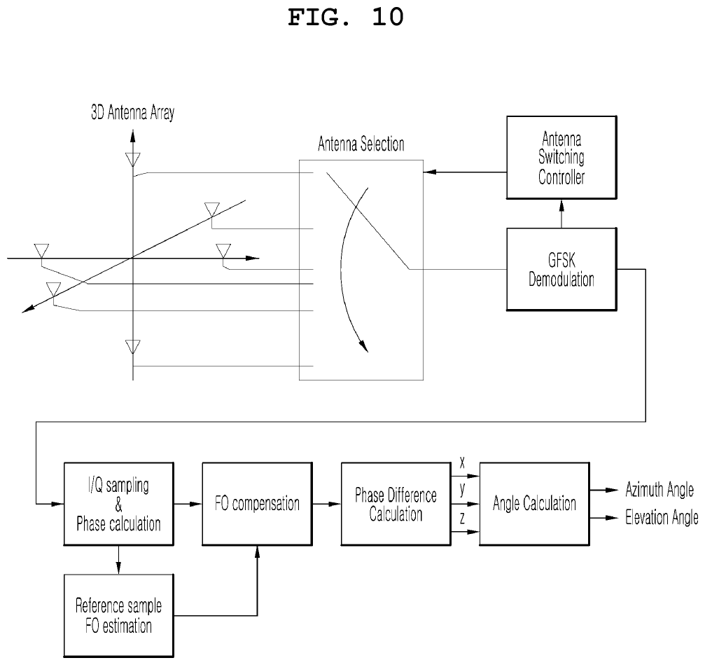

FIG. 10 is a view showing an arrangement of six antennas in a three-dimensional space and a structure of a receiver for calculating an azimuth angle and an elevation angle according to the exemplary embodiment of the present invention.

The receiver that is presented in FIG. 10 shows that a procedure for calculating an angle of arrival described above and arrangement of antennas in the three-dimensional space are synthesized. The receiver may include: an antenna array including six antennas arranged in a three-dimensional space; an antenna switch configured to select an antenna to receive a signal from among the antennas of the antenna array; a demodulator configured to demodulate a Bluetooth signal (i.e., gaussian frequency-shift keying (GFSK) demodulation); a partial antenna switch controller configured to sequentially controlling antenna switching; a phase calculator configured to calculate a phase by extracting an In-phase/Quadrature (I/Q) sample from a CTE signal; a frequency offset estimator configured to estimate a frequency offset by using a reference sample; a frequency offset compensator configured to compensate for the frequency offset to the calculated phase; a phase difference calculator configured to average phases of each antenna and calculate an x-axis phase difference Ψx, a y-axis phase difference Ψy, and a z-axis phase difference Ψz; and an angle of arrival calculator configured to calculate an azimuth angle and an elevation angle by using the phase difference values.

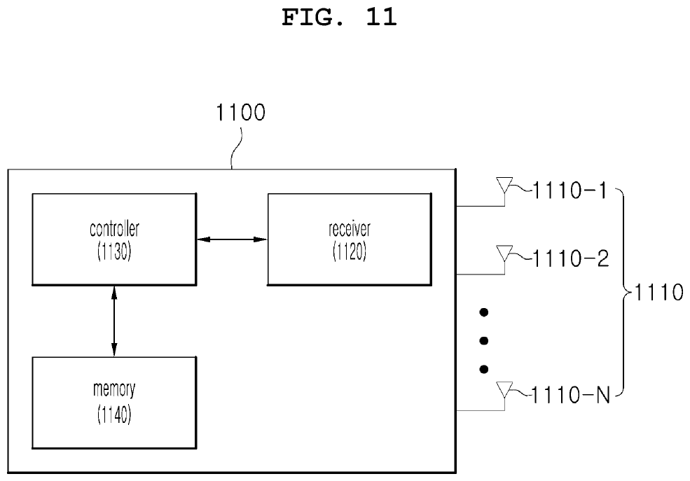

FIG. 11 is a view showing an example of a device (i.e., Bluetooth communication device) 1100 for direction finding in the Bluetooth communication system according to the exemplary embodiment of the present invention. FIG. 11 shows the example of the device capable of performing Bluetooth communication, and the device may belong to either a master device or a slave device in the Bluetooth communication system. The device 1100 for direction finding in the Bluetooth communication system according to the exemplary embodiment of the present invention includes: an antenna array 1110 including a plurality of antennas; a receiver 1120 configured to be electrically connected to the antenna array 1110 and receive a signal through the antenna array 1110; a controller 1130 configured to be electrically connected to the receiver 1120 and process the received signal; and a memory 1140 configured to store the received signal or information necessary for control. In FIG. 11, the memory 1140 may be omitted or may be included in the controller 1130. Although FIG. 11 shows only the receiver 1120, FIG. 11 may also include a transmitter that performs up-conversion, modulation, and the like for signal transmission. In addition, in the exemplary embodiment of the present invention, the Bluetooth communication device 1100 may include a transceiver in which a transmitter and a receiver are integrated.

The antenna array 1110 may include two or more antennas 1110-1 to 1110-N, where N is an integer greater than 2. According to the exemplary embodiment of the present invention, the antenna array 1110 may include: a first antenna and a second antenna installed along a first direction (e.g., X-axis direction), and a third antenna and a fourth antenna installed along a second direction (e.g., Y-axis direction) perpendicular to the first direction. For example, as shown in FIG. 7, the antenna array 1110 may include: antennas Ant1 and Ant3 installed along the X-axis direction; and antennas Ant2 and Ant4 installed along the Y-axis direction.

In addition, for direction finding in the three-dimensional space, the antenna array 1110 may further include: a fifth antenna and a sixth antenna installed along a third direction (e.g., Z-axis direction) perpendicular to the first direction (e.g., X-axis direction) and the second direction (e.g., Y-axis direction). For example, as shown in FIG. 9, in addition to the antennas Ant1 and Ant3 installed along the X-axis direction and the antennas Ant2 and Ant4 installed along the Y-axis direction, the antenna array 1110 may include the antennas Ant5 and Ant6 installed along the Z-axis direction.

According to the exemplary embodiment of the present invention, a distance (d<=λ/2) between antennas included in the antenna array may be less than or equal to half the wavelength of a Bluetooth packet signal.

According to the exemplary embodiment of the present invention, the receiver 1120 receives a radio frequency (RF) signal in accordance with the Bluetooth communication standard through the antenna array. The receiver 1120 may restore a Bluetooth packet through a procedure including filtering, conversion, and the like, for the RF signal. For example, the receiver 1120 may include: an antenna switch and an antenna switching controller, which are configured to select an antenna to receive an RF signal from among the antennas of an antenna array; and a demodulator configured to demodulate (e.g., GFSK demodulation) the RF signal received from the selected antenna.

According to the exemplary embodiment of the present invention, as shown in FIG. 1, the received packet signal includes the preamble, the access address, the PDU, the CRC, and the CTE. Here, as a sample that may be selectively transmitted for direction finding, the CTE may be inserted after the CRC. As shown in FIG. 2, the CTE may include a reference sample and a sample received for each antenna of the antenna array 1110. As the exemplary embodiment, when there are four antennas, the CTE may include: a first set of samples received by a first antenna during a first period; a second set of samples received by a second antenna during a second period; a third set of samples received by a third antenna during a third period; and a fourth set of samples received by a fourth antenna during a fourth period.

The controller 1130 may control the operation of the receiver 1120 and perform processing on the received signal. The controller 1130 may include one or more processors (i.e., processing circuits) for controlling the receiver 1120 and processing signals. For direction finding, the controller 1130 may extract phase values of samples included in the CTE of a packet signal, and determine an angle of arrival and an incident direction of the packet signal on the basis of a difference between the phase values. More specifically, in the packet signal, the controller 1130 determines: phase values of a first phase value of the first set of samples received by the first antenna and a second phase value of the second set of samples received by the second antenna, the first and second antennas installed along the first direction (e.g., X axis direction); and phase values of a third phase value of the third set of samples received by the third antenna and a fourth phase value of the fourth set of samples received by the fourth antenna, the third and fourth antennas installed along the second direction (e.g., Y-axis direction) perpendicular to the first direction. Thereafter, it is possible to determine the angle of arrival and the incident direction of the packet signal on the basis of a first-axis phase difference (e.g., X-axis phase difference) corresponding to a difference between the first phase value and the second phase value; and a second-axis phase difference (e.g., Y-axis phase difference) corresponding to a difference between the third phase value and the fourth phase value.

According to the exemplary embodiment of the present invention, the above-described set of samples may include two or more samples received by a specific antenna during a specific period, and the phase value for direction finding may correspond to an average phase values of each of the samples included in the set of samples.

According to the exemplary embodiment of the present invention, the angle of arrival of the packet signal may be determined on the basis of a first-axis phase difference (e.g., X-axis phase difference) that is the phase difference between the first antenna and the second antenna; a distance between the first antenna and the second antenna; and a wavelength of the received packet signal. As described above, when the first-axis phase difference is T, the distance between antennas is d, and the wavelength of the packet signal is A, the angle of arrival of the packet signal may be calculated by an equation: θ=cos⁻¹ [λ/d*Ψ/360]. In addition, four antennas are installed as in the exemplary embodiment of the present invention, wherein two antennas are installed along the first direction (e.g., X-axis direction), and the remaining two antennas are installed along the second direction (e.g., Y-axis direction) perpendicular to the first direction, so that all ranges of angles of arrival between 0 degrees and 360 degrees in a two-dimensional plane may be distinguished. That is, as shown in Table 3, the incident direction of the packet signal may be derived through a combination of the first-axis phase difference (i.e., X-axis phase difference) Tx and the second-axis phase difference (i.e., Y-axis phase difference) Ty.

According to the exemplary embodiment of the present invention, the distance between the antennas in the antenna array 1110 may be set to be less than or equal to the wavelength of the packet signal. As described above, the angle of arrival θ of the packet signal and the phase difference Ψ between the antennas have a relationship of Ψ=2π(d/λ)cos(θ), and considering that −1<=cos(θ)<=1, the phase difference Ψ has a range of −2π(d/λ)<=Ψ<=2π(d/λ). Accordingly, in order for the phase difference Ψ to be uniquely determined according to the angle of arrival θ, the distance d between the antennas should be less than or equal to half the wavelength λ (i.e., d<=λ/2). In other words, the distance between the first antenna and the second antenna may be set to be less than or equal to half the wavelength of the packet signal.

In addition, according to the exemplary embodiment of the present invention, in order to determine an azimuth angle and an elevation angle at which a packet signal received in a three-dimensional space is incident, antennas (i.e., a fifth antenna and a sixth antenna) may be installed along the third direction (e.g., Z-axis direction) perpendicular to the first direction (e.g., X-axis direction) and the second direction (e.g., Y-axis direction). In this case, the CTE may further include: a fifth set of samples received by the fifth antenna during a fifth period; and a sixth set of samples received by the sixth antenna during a sixth period. The controller 1130 may determine a fifth phase value of the fifth set of samples and a sixth phase value of the sixth set of samples. Here, the fifth phase value may be an average phase values of samples received by the fifth antenna during the fifth period, and the sixth phase value may be an average phase values of samples received by the sixth antenna during the sixth period. The controller 1130 may determine: a third-axis phase difference (e.g., Z-axis phase difference) corresponding to a difference between the fifth phase value and the sixth phase value; and an azimuth angle and an elevation angle, at which a packet signal is incident, on the basis of the first-axis phase difference, the second-axis phase difference, and the third-axis phase difference.

More specifically, as shown in FIG. 10, the controller 1130 may extract a reference sample and initial phase values of the first set of samples to the sixth set of samples from the CTE of the packet signal received through I/Q sampling, calculate a frequency offset by using the reference sample, and perform compensation for the initial phase values by using the frequency offset, so that final phase values (i.e., the first phase value to the sixth phase value) may be determined. As described above, the controller 1130 may determine the first-axis phase difference (e.g., X-axis phase difference), the second-axis phase difference (e.g., Y-axis phase difference), and the third-axis phase difference (e.g., Z-axis phase difference) from the first to sixth phase values, and may determine the azimuth angle and the elevation angle, at which the packet signal is incident, from the first-axis phase difference (e.g., X-axis phase difference), the second-axis phase difference (e.g., Y-axis phase difference), and the third-axis phase difference (e.g., Z-axis phase difference).

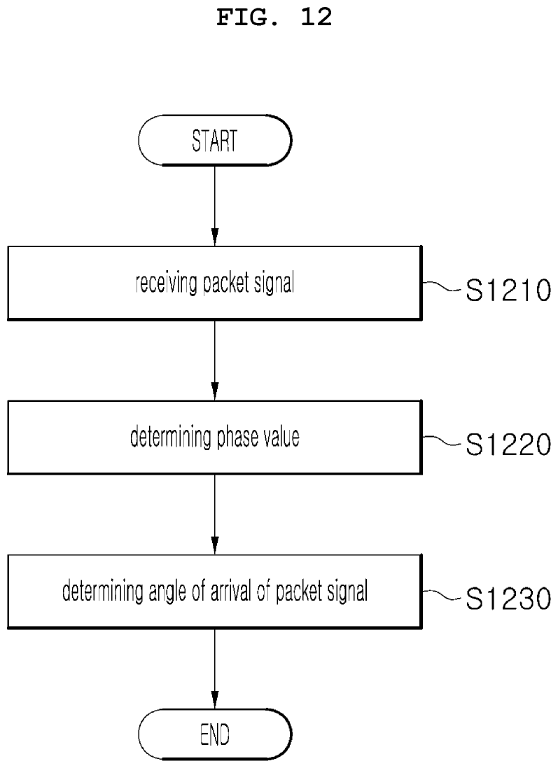

FIG. 12 a view showing an example of a process for direction finding in the Bluetooth communication system according to the exemplary embodiment of the present invention. The operations of FIG. 12 may be performed by the Bluetooth communication device 1100 (i.e., receiver 1120 or controller 1130) shown in FIG. 11.

Referring to FIG. 12, in step S1210, the Bluetooth communication device 1100 receives a packet signal including a CTE through an antenna array including a plurality of antennas. Here, the CTE is a signal that includes a sample for direction finding, and may include: the first set of samples received by the first antenna during the first period; the second set of samples received by a second antenna during the second period; the third set of samples received by a third antenna during the third period; and the fourth set of samples received by a fourth antenna during the fourth period.

In the exemplary embodiment of the present invention, the packet signal includes: the preamble, the access address, the PDU, the CRC, and the CTE, and the CTE may be inserted after the CRC.

Thereafter, in step S1220, the Bluetooth communication device 1100 determines: the first phase value of the first set of samples; the second phase value of the second set of samples; the third phase value of the third set of samples; and the fourth phase value of the fourth set of samples. In the exemplary embodiment of the present invention, the first phase value may correspond to the average phase value of samples received by the first antenna during the first period, the second phase value may correspond to the average phase value of samples received by the second antenna during the second period, the third phase value may correspond to the average phase value of samples received by the third antenna during the third period, and the fourth phase value may correspond to the average phase value of samples received by the fourth antenna during the fourth period.

In step S1230, the Bluetooth communication device 1100 determines the angle of arrival and the incident direction of the packet signal on the basis of the phase differences, including: the first-axis phase difference (e.g., X-axis phase difference) corresponding to the difference between the first phase value and the second phase value; and the second-axis phase difference (e.g., Y-axis phase difference) corresponding to the difference between the third phase value and the fourth phase value. In the exemplary embodiment of the present invention, the angle of arrival of the packet signal may be determined on the basis of the first-axis phase difference, the distance between the first antenna and the second antenna, and the wavelength of the packet signal, and the incident direction of the packet signal may be determined on the basis of the first-axis phase difference and the second-axis phase difference. In addition, the distance between the first antenna and the second antenna may be less than or equal to half the wavelength of the packet signal.

In addition, for direction finding in the three-dimensional space, the antenna array according to the exemplary embodiment of the present invention may further include the fifth antenna and the sixth antenna installed along the third direction (e.g., Z-axis direction) perpendicular to the first direction (e.g., X-axis direction) and the second direction (e.g., Y-axis direction). In this case, the CTE may further include: the fifth set of samples received by the fifth antenna during the fifth period; and the sixth set of samples received by the sixth antenna during the sixth period. The Bluetooth communication device 1100 may determine the phase values of the fifth set of samples and the phase value of the sixth set of samples, may determine the third-axis phase difference (e.g., Z-axis phase difference) corresponding to the difference between the fifth phase value and the sixth phase value, and may determine the azimuth angle and the elevation angle, at which a packet signal is incident, on the basis of the first-axis phase difference, the second-axis phase difference, and the third-axis phase difference.

According to the exemplary embodiment of the present invention, the Bluetooth communication device 1100 may select an antenna to receive an RF signal from among the antennas of the antenna array and perform demodulation on the RF signal received from the selected antenna. In addition, in step S1220, the Bluetooth communication device 1100 extracts the reference sample and the first to sixth set of samples from the CTE through In-phase/Quadrature (I/Q) sampling, determines the initial phase values of the first to sixth set of samples, calculates the frequency offset from the reference sample, and performs compensation for the initial phase values by using the frequency offset, so that the first phase value to the sixth phase value may be determined.

In step S1230, the Bluetooth communication device 1100 determines the first-axis phase difference, the second-axis phase difference, and the third-axis phase difference from the first phase value to the sixth phase value, and determines the azimuth angle and the elevation angle, at which the packet signal is incident, on the basis of the first-axis phase difference, the second-axis phase difference, and the third-axis phase difference.

The present exemplary embodiment and the accompanying drawings in this specification only clearly show a part of the technical idea included in the present invention, and it will be apparent that all modifications and specific exemplary embodiments that can be easily inferred by those skilled in the art within the scope of the technical spirit contained in the specification and drawings of the present invention are included in the scope of the present invention.

Therefore, the spirit of the present invention should not be limited to the described exemplary embodiments, and all things equal or equivalent to the claims as well as the claims to be described later fall within the scope of the concept of the present invention.

What is claimed is:

1. A device for direction finding in a Bluetooth communication system, the device comprising:
an antenna array comprising a plurality of antennas, the antenna array comprising a first antenna and a second antenna which are installed along a first direction and a third antenna and a fourth antenna which are installed along a second direction perpendicular to the first direction;
a receiver electrically connected to the plurality of antennas and configured to transmit or receive a signal through the antenna array; and
a controller electrically connected to the receiver and configured to perform controlling of the receiver and processing of the received signal,
wherein the receiver receives a packet signal comprising a constant tone extension (CTE),
the CTE comprises:
a first set of samples received by the first antenna during a first period;
a second set of samples received by the second antenna during a second period;
a third set of samples received by the third antenna during a third period; and
a fourth set of samples received by the fourth antenna during a fourth period, and
the controller determines:
a first phase value of the first set of samples;
a second phase value of the second set of samples;
a third phase value of the third set of samples; and
a fourth phase value of the fourth set of samples, and determines an angle of arrival and an incident direction of the packet signal on the basis of a first-axis phase difference corresponding to a difference between the first phase value and the second phase value and a second-axis phase difference corresponding to a difference between the third phase value and the fourth phase value.

2. The device of claim 1, wherein the packet signal comprises a preamble, an access address, a protocol data unit (PDU), a cyclic redundancy check (CRC), and the CTE, and the CTE is inserted after the CRC.

3. The device of claim 1, wherein the first phase value is an average phase value of samples received by the first antenna during the first period,
the second phase value is an average phase value of samples received by the second antenna during the second period,
the third phase value is an average phase value of samples received by the third antenna during the third period, and
the fourth phase value is an average phase value of samples received by the fourth antenna during the fourth period.

4. The device of claim 1, wherein the angle of arrival of the packet signal is determined on the basis of the first-axis phase difference, a distance between the first antenna and the second antenna, and a wavelength of the packet signal, and
the incident direction of the packet signal is determined on the basis of the first-axis phase difference and the second-axis phase difference.

5. The device of claim 4, wherein the distance between the first antenna and the second antenna is less than or equal to half the wavelength of the packet signal.

6. The device of claim 1, wherein the antenna array further comprises a fifth antenna and a sixth antenna which are installed along a third direction perpendicular to the first direction and the second direction,
the CTE further comprises a fifth set of samples received by the fifth antenna during a fifth period, and a sixth set of samples received by the sixth antenna during a sixth period, and
the controller determines a fifth phase value of the fifth set of samples and a sixth phase value of the sixth set of samples, determines a third-axis phase difference corresponding to a difference between the fifth phase value and the sixth phase value, and determines an azimuth angle and an elevation angle, at which the packet signal is incident, on the basis of the first-axis phase difference, the second-axis phase difference, and the third-axis phase difference.

7. The device of claim 6, wherein the receiver comprises:
an antenna switch and an antenna switching controller which are configured to select an antenna to receive a radio frequency (RF) signal from among the plurality of antennas; and
a demodulator configured to demodulate the RF signal received from the selected antenna.

8. The device of claim 7, wherein the controller extracts a reference sample and initial phase values of the first set of samples to sixth set of samples from the CTE through In-phase/Quadrature (I/Q) sampling, calculates a frequency offset of the packet signal by using the reference sample, determines the first phase value to the sixth phase value by performing compensation on the initial phase values by using the frequency offset, determines the first-axis phase difference, the second-axis phase difference, and the third-axis phase difference from the first to the sixth phase values, and determines the azimuth angle and the elevation angle, at which the packet signal is incident, on the basis of the first-axis phase difference, the second-axis phase difference, and the third-axis phase difference.

9. A method for direction finding in a Bluetooth communication system, the method comprising:
receiving a packet signal comprising a constant tone extension (CTE) through an antenna array comprising a plurality of antennas, the CTE comprising a first set of samples received by a first antenna during a first period, a second set of samples received by a second antenna during a second period, a third set of samples received by a third antenna during a third period, and a fourth set of samples received by a fourth antenna during a fourth period;
determining a first phase value of the first set of samples, a second phase value of the second set of samples, a third phase value of the third set of samples, and a fourth phase value of the fourth set of samples; and
determining an angle of arrival and an incident direction of the packet signal on the basis of a first-axis phase difference corresponding to a difference between the first phase value and the second phase value and a second-axis phase difference corresponding to a difference between the third phase value and the fourth phase value.

10. The method of claim 9, wherein the packet signal comprises a preamble, an access address, a protocol data unit (PDU), a cyclic redundancy check (CRC), and the CTE, and
the CTE is inserted after the CRC.

11. The method of claim 9, wherein the first phase value is an average phase value of samples received by the first antenna during the first period,
the second phase value is an average phase value of samples received by the second antenna during the second period,
the third phase value is an average phase value of samples received by the third antenna during the third period, and
the fourth phase value is an average phase value of samples received by the fourth antenna during the fourth period.

12. The method of claim 9, wherein the angle of arrival of the packet signal is determined on the basis of the first-axis phase difference, the distance between the first antenna and the second antenna, and a wavelength of the packet signal, and
the incident direction of the packet signal is determined on the basis of the first-axis phase difference and the second-axis phase difference.

13. The method of claim 12, wherein the distance between the first antenna and the second antenna is less than or equal to half the wavelength of the packet signal.

14. The method of claim 9, wherein the antenna array further comprises:
a fifth antenna; and
a sixth antenna, the fifth and sixth antennas installed along a third direction perpendicular to the first direction and the second direction, and
the CTE further comprises:
a fifth set of samples received by the fifth antenna during a fifth period; and
a sixth set of samples received by the sixth antenna during a sixth period.

15. The method of claim 14, further comprising:
determining a fifth phase value of the fifth set of samples and a sixth phase value of the sixth set of samples, determining a third-axis phase difference corresponding to a difference between the fifth phase value and the sixth phase value, and determining an azimuth angle and an elevation angle, at which the packet signal is incident, on the basis of the first-axis phase difference, the second-axis phase difference, and the third-axis phase difference.

16. The method of claim 15, wherein the receiving of the packet signal comprises:
selecting an antenna to receive a radio frequency (RF) signal from among the plurality of antennas; and
performing demodulation on the RF signal received from the selected antenna.

17. The method of claim 16, wherein the determining of the first phase value and the second phase value comprises:
extracting a reference sample and the first set of samples to sixth set of samples from the CTE through In-phase/Quadrature (I/Q) sampling;
determining initial phase values of the first set of samples to sixth set of samples;
calculating a frequency offset from the reference sample; and
determining the first phase value to the sixth phase value by performing compensation on the initial phase values by using the frequency offset, and
the determining of the angle of arrival of the packet signal comprises:
determining the first-axial phase difference, the second-axial phase difference, and the third-axial phase difference from the first phase value to sixth phase value; and
determining the azimuth angle and the elevation angle, at which the packet signal is incident, on the basis of the first-axis phase difference, the second-axis phase difference, and the third-axis phase difference.
